(19) United States
(12) Patent Application Publication
(10) Pub. No.: US 2009/0084707 A1
(43) Pub. Date: Apr. 2, 2009

(54) METHOD OF UPGRADING BITUMEN AND HEAVY OIL

(75) Inventor: Henry Gil, Calgary (CA)

Correspondence Address: SHERIDAN ROSS PC, 1560 BROADWAY, SUITE 1200, DENVER, CO, 80202, US

(73) Assignee: OSUM OIL SANDS CORP., Calgary (CA)

(21) Appl. No.: 12/237,163

(22) Filed: Sep. 24, 2008

Related U.S. Application Data
(60) Provisional application No. 60/976,124, filed on Sep. 28, 2007.

(51) Int. Cl. C10G 9/00; B01J 19/08; F02C 6/00

(52) U.S. Cl. 208/106; 204/168; 204/170; 60/784

(57) ABSTRACT

The invention is directed to separating a hydrocarbon feed-stock such as bitumen or heavy oil, into a de-asphalted oil component and a residue component comprising primarily asphaltenes. The asphaltenes with some added bitumen are converted by a plasma arc reactor into a controllable mixture of primarily paraffins and impurities. Natural gas liquids are separated out by refrigeration. The lighter paraffins may be used to operate a steam or gas turbine to produce electrical energy which, in turn, may be used to provide power for generating steam, for powering the plasma arc reactor and other apparatuses of an on-site processing plant or excess power may be sold to the grid.

### CROSS REFERENCE TO RELATED APPLICATION

The present application claims the benefits, under 35 U.S.C. §119(e), of U.S. Provisional Application Ser. No. 60/976,124 filed Sep. 28, 2007, entitled “Method of Upgrading Bitumen and Heavy Oil” to Gil, which is incorporated herein by this reference.

Cross reference is made to: U.S. Pat. No. 7,128,375 issued Oct. 31, 2006 entitled “A Method and Means for Recovering Hydrocarbons from Oil Sands by Underground Mining”; U.S. patent application Ser. No. 11/441,929 filed May 26, 2006 entitled “Method for Underground Recovery of Hydrocarbons”; and U.S. patent application Ser. No. 11/944,013 filed Nov. 21, 2007 entitled “Recovery of Bitumen by Hydraulic Excavation”, all of which are also incorporated herein by these references.

### FIELD

The present invention relates generally to an on-site method and plant to process and partially upgrading bitumen and/or heavy oil recovered by in-situ or mining methods.

### BACKGROUND

Oil is a nonrenewable natural resource having great importance to the industrialized world. The increased demand for and decreasing supplies of conventional oil has led to the development of alternate sources of oil, such as deposits of bitumen and heavy crude, as well as a search for more efficient methods for recovery and processing from such hydrocarbon deposits.

There are substantial deposits of oil sands in the world, with particularly large deposits in Canada and Venezuela. For example, the Athabasca oil sands region of the Western Canadian Sedimentary Basin contains an estimated 1.3 trillion barrels of potentially recoverable bitumen. An equally large deposit of bitumen may be found in the Carbonates of Alberta. There are lesser, but significant deposits, found in the U.S. and other countries. These oil sands and carbonate reservoirs contain a petroleum substance called bitumen or heavy oil. Bitumen deposits cannot be economically exploited by traditional oil well technology because the bitumen or heavy oil is too viscous to flow at natural reservoir temperatures.

When oil sand deposits are near the surface, they can be economically recovered by surface mining methods. The current principal method of bitumen recovery, for example, in the Alberta oil sands is by conventional surface mining of shallower deposits using large power shovels and trucks to feed a nearby slurry conversion facility, which is connected to a primary bitumen extraction facility by a long hydro-transport haulage system. The bitumen is finally taken to an upgrader facility where it is refined and converted into crude oil and other petroleum products.

When oil sand deposits are too far below the surface for economic recovery by surface mining, bitumen can be economically recovered in many, but not all, areas by recently developed in-situ recovery methods, such as SAGD (Steam Assisted Gravity Drain), VAPEX, and other variants of gravity drainage technology to mobilize the bitumen or heavy oil. The principal method currently being implemented on a large scale is Steam Assisted Gravity Drain (“SAGD”). Typically, SAGD wells, or well pairs, are drilled from the earth's surface down to the bottom of the oil sand deposit and then horizontally along the bottom of the deposit. The wells inject steam to reduce the viscosity of bitumen. The wells then collect the mobilized bitumen.

The SAGD method has been applied to heavy oil and bitumen recovery with varying degrees of success, both in terms of total recovery factor and economics. A SAGD operation may be characterized by its Steam-Oil-Ratio (“SOR”), which is a measure of how much steam is used to recover a barrel of heavy oil or bitumen (the SOR is the ratio of the number of barrels of water required to produce the steam to the number of barrels of oil or bitumen recovered). Thus, an SOR of 3 means that 3 barrels of water are required to be injected as high temperature steam to recover 1 barrel of oil or bitumen). This ratio is often determined by geological factors within the reservoir and therefore may be beyond the control of the operator. Examples of these geological factors are clay, mudstone, or shale lenses, that impede the migration of steam upwards and the flow of mobilized oil downwards, or thief zones comprised of formation waters. An acceptable SOR may be in the range of 2 to 3 whereas an uneconomical SOR is commonly 3 or higher. A SAGD operation with an average SOR of 3 requires energy to produce steam equivalent to about 25% to 35% of a barrel of bitumen to produce the next barrel of bitumen.

HAGD is a relatively new process for mobilizing bitumen in the Alberta oil sands and in carbonates. Electric heater elements are embedded in the reservoir material and used, in place of steam, to heat the formation until the bitumen becomes fluid enough to flow by gravity drain. HAGD may require more energy than SAGD but may be used in reservoirs where SAGD cannot—such as, for example, reservoirs with poor steam caps. HAGD and SAGD may also be used in combination, where HAGD elements are used to melt the bitumen around the steam injectors, thereby allowing the steam chamber to form more quickly. An exemplary means of producing bitumen or heavy oil is described in U.S. Pat. No. 7,066,254 to Vinegar, et al. entitled “In Situ Thermal Processing of a Tar Sands Formation”

Because of global warming concerns, this potential for substantially increasing carbon dioxide emissions may outweigh the advantages of the enormous reserves of unconventional hydrocarbon deposits available.

Even the most efficient SAGD or HAGD operation requires substantial amounts of energy to deliver the required amount of steam or heat to the reservoir to mobilize the bitumen. If this energy is obtained by burning fossil fuels, there is the potential to generate significant amounts of carbon dioxide emissions during recovery operations. The thermal energy required to mobilize bitumen can be quantified by a Steam-Oil-Ratio (“SOR”), which is determined by the number of barrels of water required to produce the steam divided by the number of barrels of oil or bitumen recovered. In a SAGD operation having an average SOR of 3, the energy required to produce high quality steam to recover 1 barrel of heavy oil or bitumen oil is equivalent to about ¼ of a barrel of oil. Thus, oil produced by thermal recovery methods have the potential to generate 25% or more carbon dioxide emissions than oil recovered by pumping from conventional oil wells.

In addition, the upgrading process when carried out underground, such as described for example in U.S. Pat. No. 7,066,254 or at a surface refinery can generate additional carbon dioxide and other unwanted emissions.

There has been much effort to utilize all the on-site water and energy potential derived from a SAGD operation to increase the overall efficiency of the operation and to prepare the produced bitumen or heavy oil for pipeline transmission over existing pipeline networks.

There remains, therefore, a need for a process to reduce the costs of producing bitumen or heavy oil, reduce greenhouse emissions, and prepare the product on-site for pipeline transmission to a desired refinery.

### SUMMARY

These and other needs are addressed by the present invention. The various embodiments and configurations of the present invention are directed generally to a process for converting part of a heavy oil- and/or bitumen-containing feed material into a hydrocarbon gas mixture, which may be used to generate steam and natural gas. The material is typically recovered by in-situ or mining methods.

In a first embodiment, the process of the present invention combines any one of several known partial upgrading processes with a plasma arc reactor, a gas refrigeration plant, a circular fluidized boiler, and back-end flue gas clean-up to produce a substantially self-contained, self-powered bitumen or heavy oil recovery facility. A principal product material can be heavy oil or bitumen partially upgraded to about 20° API. The residual asphaltene from the upgrading process can provide much of the fuel for a plasma arc reactor. The plasma arc reactor produces lighter hydrocarbons. The steam, lighter hydrocarbons, and natural gas generated by the overall process can be used, for example, in SAGD operations, to provide much of the energy and water to inject pressurized steam into the formation for ongoing SAGD recovery of additional bitumen or heavy oil.

An aspect of the process of the embodiment is the use of plasma arc technology to convert residue from a bitumen upgrader process to recover valuable paraffin gases and unwanted impurities. For example, hydrogen H₂, methane CH₄ and ethane C₂H₆ may used as fuel gases to produce steam. Liquid Natural Gases (“LNGs”), such as propane C₃H₈, n-butane C₄H₁₀ and n-pentane C₅H₁₂, may be recovered separately and may be sold as a product.

In a first configuration, a portion of the hot, high-pressure, high-quality steam produced may be bled off and used to generate electrical power for the various apparatuses of the process of the present invention. This portion of hot, high-pressure, high-quality steam is used to operate a steam turbine to generate electricity. The output of the steam turbine is preferably a low quality steam (as opposed to a condensed water/steam mixture) which is returned to the Rising Tube Evaporator (or Falling Tube Evaporator) for recycling to the Steam Drum Generators.

In a second configuration, the steam turbine is replaced by a gas turbine. The gas turbine is fueled by fuel gases generated by the Plasma Arc Reactor and separated in the Gas Refrigeration Plant. In this configuration, power is generated directly by the fuel gases produced instead of going through the additional step of generating steam to run a steam turbine for power generation.

As can be appreciated, electrical power can be generated by a combination of a steam turbine and a gas turbine, or by a combined cycle gas turbine.

The following definitions are used herein:

“A” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Asphaltenes are molecular substances found in crude oil, along with resins, aromatic hydrocarbons, and alkanes. Asphaltenes consist primarily of carbon, hydrogen, nitrogen, oxygen, and sulfur, as well as trace amounts of vanadium and nickel. The C:H ratio is approximately 1:1.2, depending on the asphaltene source. Asphaltenes are defined operationally as the n-heptane insoluble, toluene soluble component of a carbonaceous material such as crude oil, bitumen or coal.

A combined cycle gas turbine (CCGT) is a gas turbine generator that generates electricity, wherein the waste heat is used to make steam to generate additional electricity via a steam turbine. This last step enhances the efficiency of electricity generation.

The Fluid Catalytic Cracking process or FCC produces a high yield of gasoline and Liquid Petroleum Gas or LPG. As will be appreciated, hydrocracking is a major source of jet fuel, diesel, naphtha and LPG. Thermal cracking is currently used to upgrade very heavy fractions, or to produce light fractions or distillates, burner fuel and/or petroleum coke. Two extremes of the thermal cracking in terms of product range are represented by the high-temperature process called steam cracking or pyrolysis (ca. 750 to 900° C. or more) which produces valuable ethylene and other feed stocks for the petrochemical industry, and the milder-temperature delayed coking (ca. 500° C.) which can produce, under the right conditions, valuable needle coke, a highly crystalline petroleum coke used in the production of electrodes for the steel and aluminum industries.

A Heat Recovery Steam Generator or HRSG is a heat exchanger that recovers heat from a hot gas stream. It produces steam that can be used in a process or used to drive a steam turbine. A common application for an HRSG is in a combined-cycle power station, where hot exhaust from a gas turbine is fed to an HRSG to generate steam which in turn drives a steam turbine. This combination produces electricity more efficiently than either the gas turbine or steam turbine alone. The HRSG is also an important component in cogeneration plants. Cogeneration plants typically have a higher overall efficiency in comparison to a combined cycle plant. This is due to the loss of energy associated with the steam turbine.

A mobilized hydrocarbon is a hydrocarbon that has been made flowable by some means. For example, some heavy oils and bitumen may be mobilized by heating them or mixing them with a diluent to reduce their viscosities and allow them to flow under the prevailing drive pressure. Most liquid hydrocarbons may be mobilized by increasing the drive pressure on them, for example by water or gas floods, so that they can overcome interfacial and/or surface tensions and begin to flow.

An olefin diluent is diluent made from any of a series of unsaturated open-chain hydrocarbons corresponding in composition to the general formula CₙH₂ₙ.

A paraffin is a saturated hydrocarbon with the general formula CₙH₂ₙ₊₂. For n<5 (methane, ethane, propane and butane), the paraffins are gaseous at normal temperatures and pressures. For n=5 or greater, the paraffins are liquid or solid at normal temperatures and pressures. Paraffins are often called alkanes.

Petroleum coke or pet coke is a fuel produced using the byproducts of the petroleum refining process. When crude oil is refined to produce gasoline and other products, a residue is left over from this process that can be further refined by “coking” it at high temperatures and under great pressure. The resulting product is pet coke, a hard substance that is similar to coal. Pet coke has a higher heating value than coal, at around 14,000 Btu per pound, compared with 12,500 Btu per pound for coal.

Primary production or recovery is the first stage of hydrocarbon production, in which natural reservoir energy, such as gasdrive, waterdrive or gravity drainage, displaces hydrocarbons from the reservoir, into the wellbore and up to surface. Production using an artificial lift system, such as a rod pump, an electrical submersible pump or a gas-lift installation is considered primary recovery. Secondary production or recovery methods frequently involve an artificial-lift system and/or reservoir injection for pressure maintenance. The purpose of secondary recovery is to maintain reservoir pressure and to displace hydrocarbons toward the wellbore. Tertiary production or recovery is the third stage of hydrocarbon production during which sophisticated techniques that alter the original properties of the oil are used. Enhanced oil recovery can begin after a secondary recovery process or at any time during the productive life of an oil reservoir. Its purpose is not only to restore formation pressure, but also to improve oil displacement or fluid flow in the reservoir. The three major types of enhanced oil recovery operations are chemical flooding, miscible displacement and thermal recovery.

Vapor Recovery Units or VRUs are relatively simple systems that can capture about 95 percent of the energy-rich vapors for sale or for use onsite as fuel. This is also a means of preventing emissions of these light hydrocarbon vapors which may yield significant economic savings.

It is understood that reference to a Rising Tube Evaporator may also mean a Falling Tube Evaporator since both a Rising Tube and Falling Tube Evaporator accomplish the same function in process of the present invention.

It is also understood that a reference to oil herein is intended to include low API hydrocarbons such as bitumen (API less than ˜10°) and heavy crude oils (API from ˜10° to ˜20°) as well as higher API hydrocarbons such as medium crude oils (API from ˜20° to ˜35°) and light crude oils (API higher than ˜35°).

### BRIEF DESCRIPTION OF THE DRAWINGS

FIG. 1 is a schematic of a flow process for upgrading bitumen and, using a plasma arc reactor, recovering fuel gases from the residue of the upgrader.

FIG. 2 is a schematic of an alternate flow process for upgrading bitumen and, using a plasma arc reactor, recovering fuel gases from the residue of the upgrader.

### DETAILED DESCRIPTION

There are several methods to recover bitumen from an oil sands deposit. These are:
SAGD which uses steam to mobilize the bitumen and produces a mixture of hot bitumen and substantial water;
HAGD which uses heat to mobilize the bitumen and produces a mixture of hot bitumen and some water;
VAPEX which uses a diluent to mobilize the bitumen and produces a mixture of cold bitumen, diluent and some water
mechanically excavating which is a mining process typically producing an oil sand slurry. There are known processes to de-sand the slurry to produce a mixture of cold bitumen, and water; and
hydraulic mining which uses pressurized water to fragment the oil sand and produces an oil sand slurry. There are known processes to de-sand the slurry to produce a mixture of cold bitumen, and substantial water.

In any of the above recovery processes, a mixture of bitumen, water and gases is recovered and can be further processed by the process of the present invention.

To illustrate the process of the present invention, an example of a relatively large 40,000 barrel per day SAGD operation is used for illustration. As can be appreciated, the process of the present invention can be applied to all the above methods of bitumen recovery. Only the relative amounts of water produced and the requirements for a mobilizing agent (such as steam for SAGD or diluent for VAPEX) are different.

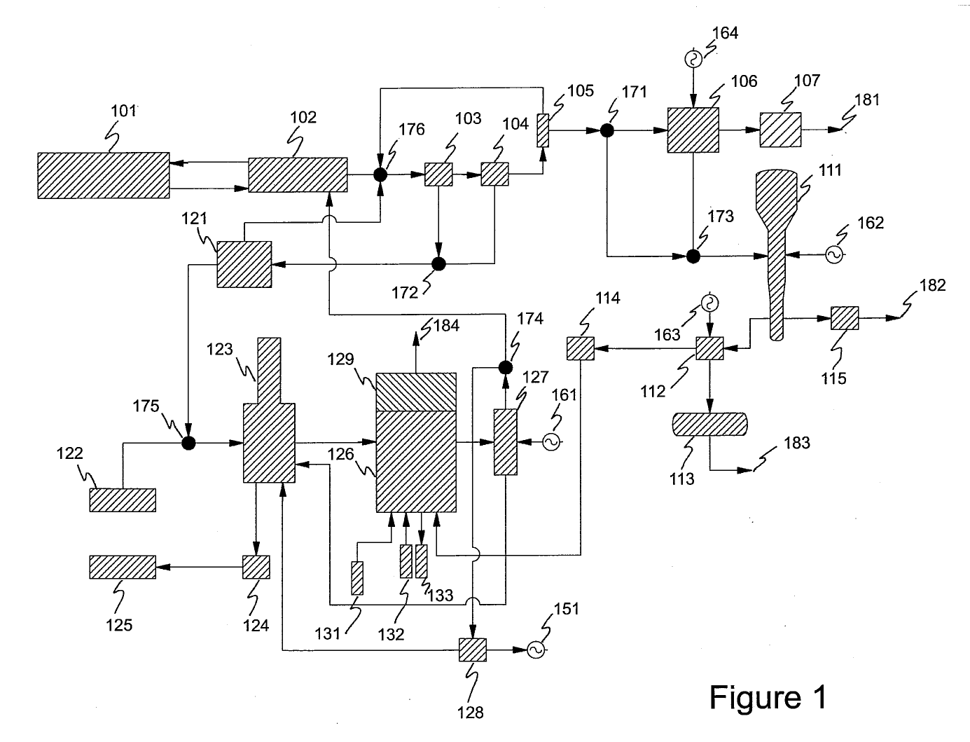

FIG. 1 shows a schematic flow chart of the process of the present invention. The main pathways of this process are:
bitumen-water separation;
bitumen upgrade by de-asphalting;
water treatment;
cracking of upgrading residue to produce paraffins and impurities;
separation of light paraffins and impurities by refrigeration;
steam and electrical power generation; and
flue gas clean-up.

The process of the present invention combines any one of several known partial upgrading processes with a plasma arc reactor, a gas refrigeration plant, a circular fluidized boiler and back-end flue gas clean-up to produce a substantially self-contained, self-powered bitumen or heavy oil recovery facility.

A unique aspect of the process of the present invention is the use of plasma arc technology to convert residue from the bitumen upgrader process to recover paraffins (CₙH₂ₙ₊₂) and other gases. For example, hydrogen H₂, methane CH₄ and ethane C₂H₆ may be recovered, separated and used as fuel gases to produce steam and electrical power. Liquid Natural Gases (“LNGs”) such as propane C₃H₈, n-butane C₄H₁₀ and n-pentane C₅H₁₂ may be recovered separately and may be sold as a product.

### Feed Stock

Heavy oils and bitumens (API less than ˜15°) contain a much larger proportion of non-distillable asphaltic residual material than do conventional oils (API greater than ˜30°). The asphaltic residual material is comprised primarily of asphaltenes and resins. Typically heavy oils and bitumens contain upwards of 20 to 30% asphaltenes. The raw feedstock for the process of the present invention is bitumen or heavy oil recovered by a mining or in-situ operation.

An example of a mining operation would be a hydraulic mining operation which produces an oil sand slurry. An example of hydraulic mining conducted from an underground workspace is disclosed in U.S. patent application Ser. No. 11/944,013 filed Nov. 21, 2007 entitled “Recovery of Bitumen by Hydraulic Excavation”. The bitumen, water and sand from a hydraulic mining operation can be separated, for example, by hydrocyclone methods. An example of this method of separation is disclosed in U.S. Pat. No. 7,128,375 issued Oct. 31, 2006, entitled “A Method and Means for Recovering Hydrocarbons from Oil Sands by Underground Mining”.

An example of an in-situ recovery operation is a SAGD operation, which produces a product stream of water, hot bitumen, and gas. SAGD operations can be carried out from a surface facility or from an underground workspace. An example of this latter approach is disclosed in U.S. patent application Ser. No. 11/441,929 filed May 26, 2006 entitled “Method for Underground Recovery of Hydrocarbons”.

An exemplary raw feedstock contains both heavy oil and bitumen. Typically, most of the hydrocarbon component of the feedstock is in the form of heavy oil.

Often bitumen recovered from a SAGD operation is shipped to a refinery for upgrading. When this is done, the bitumen is typically sold at a discount to the refinery. If shipment is made by pipeline, a diluent must be added to the bitumen to allow the blend to flow. The diluent must be recovered at the refinery and there is a cost associated with recovering the diluent, shipping it back to the site, and for the amount of diluent lost. By the present invention, recovered bitumen can be partially upgraded to an approximately 20° API de-asphalted oil, which can then be transported by pipeline without diluent and can be sold to a refinery at a substantially smaller discount than bitumen. In the process of the present invention, the residuals for the partial upgrading process are utilized to produce fuels to provide power for generating steam for on-going thermal recovery operations and for generating electrical power the operation. Finally, the flue gases are treated to minimize pollutants and greenhouse gas emissions.

### Water Treatment

The bitumen recovered from a thermal recovery operation such as SAGD or Cyclical Steam Stimulation (“CSS”) contains a large amount of water. A small fraction is connate water but most of the water is produced as condensate from the steam used to heat and mobilize the bitumen.

As shown in FIG. 1, an underground SAGD steam chamber 101 is the source of bitumen, condensed water, and water-dissolved and free gases, such as CH₄, CO₂, H₂S and other trace gases. The source material is recovered from the steam chamber by producer wells such as used, for example, in SAGD, CSS, HAGD, by non-thermal processes such as VAPEX, or by a combination of these processes that can cause the bitumen to be mobilized and recovered. The produced source material is then sent to an underground location 102 for storage and processing or for storage, pumping to the surface, and processing. Thus, the process of the present invention may be carried out on the surface, underground or portions of the process may be carried out underground. While the producer well-heads are assumed to be underground for purposes of the present illustration, the well heads may be located on the surface.

One of the products of the process of the present invention is hot, dry, pressurized steam, which may be returned to the underground location 102 and finally to the reservoir 101 for ongoing steaming (SAGD or CSS) operations. Other products of the process of the present invention, such as for example, CO₂, NOₓ and SO₂, may also be captured and returned to the underground location 102 and finally to the reservoir 101 or other geologic repository for sequestration.

The raw bitumen-water feedstock from underground storage 102 is fed into a bitumen-water separation sequence comprising a Free Water Knock-Out (“FWKO”) unit 103. Diluent is added to the raw bitumen-water feedstock to form a pumpable mixture prior to entering the FWKO unit 103. The FWKO unit 103 separates most of the water, which is then sent to a de-oiling unit 121 for final cleaning of remaining oil residue. The oil residue from the de-oiling unit 121 is returned via junction 176 to the feedstock of the FWKO unit 103. Make-up water from a water source 122 (for example a water well), is added to the de-oiled water at junction 175 and then fed to a Rising Tube Evaporator 123 which distills the water in preparation for making steam. Some water is condensed in the Rising Tube Evaporator 123, processed by a blow-down treatment apparatus 124, and then returned to the ground via a water disposal well 125. It is understood that reference to a Rising Tube Evaporator may also mean a Falling Tube Evaporator since both a Rising Tube and Falling Tube Evaporator accomplish the same function in process of the present invention.

In a typical 40,000 barrel per day (“bpd”) bitumen recovery operation, about 80,000 to about 150,000 bpd of water may be recovered. Most of this is condensate when a thermal process, such as SAGD, is used. Typically there is on the order of about 100 to 125 kg of connate water and on the order of about 200 to 300 kg bitumen recovered for every cubic meter of in-situ deposit mobilized. In a typical 40,000 bpd SAGD bitumen recovery operation, an amount of make-up water from the water well source 122 is added at junction 175 to the de-oiled water prior to being fed to the Rising Tube Evaporator (or Falling Tube Evaporator) 123. The amount of make-up water is in the range of approximately 5% to 15% of the amount of water recovered from the SAGD operation.

### Bitumen Upgrading

The de-oiled bitumen-diluent mixture from the FWKO unit 103 is fed to an oil treating unit 104, where residual water (in the approximate range of 1,000 to 2,000 parts per million (“ppm”)) is removed and added at junction 172 to the input of the water de-oiling unit 121. The treated hydrocarbon mixture is then sent to a unit 105, where the diluent is removed and returned to the raw bitumen-water feedstock stream at junction 176. The resulting hydrocarbon mixture, containing most of the bitumen in the mixture, is then fed to an upgrader unit 106. The upgrader unit 106 may be based on the well-known UOP Solvent De-Asphalting (“SDA”) process or KBR Residuum Oil Supercritical Extraction (“ROSE”) process. The principal output of the upgrader process is an approximately 20° API de-asphalted oil 181 which is stored in a De-Asphalted Oil (“DAO”) tank 107 ready for shipping via pipeline to an off-site refinery. The de-asphalted oil typically contains less than a few percent of asphaltenes. The residue from the upgrader 106 is an asphaltene fuel that, in the process of the present invention, is sent to a Plasma Arc Reactor 111 for further processing. The residue contains nearly all the asphaltenes present in the original feedstock along with all the metal and sulphur impurities.

In a typical 40,000 bpd bitumen recovery operation, about 32,000 bpd of de-asphalted oil is produced and about 6,000 bpd of residual asphaltene fuel remains. In a typical operation, the amount of de-asphalted oil 181 produced ranges from about 70% to about 90% by volume of the incoming bitumen or heavy oil feedstock. The amount of asphaltenes remaining is the difference between the volume of incoming feedstock and the volume of de-asphalted oil. The residual asphaltene fuel is supplemented by an amount of bitumen (typically about ⅓ of the asphaltene fuel or 2,000 bpd in the present example) and sent to the Plasma Arc Reactor 111.

### Gas Recovery

In a typical 40,000 bpd bitumen recovery operation with a Gas-to-Oil Ratio (“GOR”) of 2, an estimated 450 thousand standard cubic feet (“Mscf”) of gas may be recovered. This divides typically into about 80% methane and about 20% carbon dioxide. Thus about 360 Mscf of methane, CH₄ and 90 Mscf carbon dioxide, CO₂ is recovered.

Some bitumen, taken from apparatus 105, is removed at junction 171 and is added at junction 173 to the asphaltene fuel from the upgrader unit 106 and the resultant mixture is fed to the Plasma Arc Reactor 111, where it is combusted at temperatures in the range of about 300 C to over about 1,000 C. This use of a Plasma Arc Reactor 111 is a significant of the present invention. This Plasma Arc Reactor breaks down the bitumen-asphaltene fuel and produces gases and some solid residues. The selection of Plasma Arc Reactor combustion temperature is made to produce the desired composition of fuel gases generated by the Plasma Arc Reactor. The combustion temperature selected controls the degree of cracking of carbon chains that is required to produce the desired composition of fuel gases.

The gases resulting from the Plasma Arc Reactor combustion are subsequently fed to a Gas Refrigeration Plant 112 while the solid residues, for example iron (FE), vanadium (Va) and nickel (Ni), are recovered and stored in tank 115 where they may provide a separate product 182. The Gas Refrigeration Plant 112 is operated at typically about 600 psi and −40 C. The temperature is kept above the boiling point of hydrogen sulphide so that only the Natural Gas Liquid (“NGL”) products remain as liquids. This process produces NGL products 183 stored in a tank 113 for delivery as products or use in other on-site activities. The NGL products 183 are typically propane C₃H₈, n-butane C₄H₁₀ and n-pentane C₅H₁₂. The Gas Refrigeration Plant 112 therefore separates out all gases such as, for example, methane CH₄, ethane C₂H₆, carbon monoxide (CO), carbon dioxide (CO₂), hydrogen sulphide (H₂S) and NOXs. These may be captured such as for example in a tank 114 or fed directly to Steam Drum Generators 126. The gases separated in the Gas Refrigeration Plant 112 are used as fuel in steam production, electricity generation or captured for Enhanced Recovery Operations (“EOR”), sequestration or further processing.

In a typical 40,000 bpd bitumen recovery operation, the Plasma Arc Reactor 111 would require electrical power in the range of about 25 megawatts (“MW”) to about 60 MW of electrical power to provide a suitable carbon arc. Several hundred gallons of sweet NGL product are produced per day and stored in tank 113. About 100 to 120 Mscf of other gases are produced, processed and used for fuel in steam production, primarily for on-going SAGD or other thermal recovery operations, or for electricity generation.

### Steam Generation

The distilled water from the Rising Tube Evaporator (or Falling Tube Evaporator) 123 is fed to the Steam Drum Generators 126 (circular fluidized boilers) which are used to produce primarily hot dry steam which is sent to a High Pressure Steam Separator unit 127. Hydrogen, methane, ethane and other fuel gases from the Refrigeration Plant 112 are used to power the Steam Drum Generators 126. The primary function of the Steam Drum Generators 126 is to produce high quality steam which is transferred to the High Pressure Steam Separator unit 127.

The High Pressure Steam Separator unit 127 compresses the steam from the Steam Drum Generators 126 and delivers the hot, high-pressure, high-quality steam to the underground facility 102 for subsequent use in maintaining temperature and pressure conditions in steam chamber 101. Water condensate from the High Pressure Steam Separator unit 127 is returned to the Rising Tube Evaporator (or Falling Tube Evaporator) 123. A portion of the hot, high-pressure, high-quality steam may be bled off at junction 174 and used to generate electrical power for the various apparatuses of the process of the present invention. This portion of hot, high-pressure, high-quality steam is used to operate a Steam Turbine 128 to generate electricity. The output of the Steam Turbine 128 is preferably a low quality steam (as opposed to a condensed water/steam mixture) which is returned to the Rising Tube Evaporator (or Falling Tube Evaporator) 123 for recycling to the Steam Drum Generators 126.

A supply of fuel gas 131 may be required for initial process start-up from an external source such as, for example, a pipeline.

### Flue Gas Clean-Up

The flue gases produced in the Steam Drum Generators 126 by combustion of fuel gases produced in the Refrigeration Plant 112 are treated to remove particulate matter, NOxs, capture sulphur and CO₂. An electrostatic precipitator process may be used to clean-up particulate matter, for example. A catalytic converter process may be used for removing NOxs, for example. Sulphur may be removed by injecting limestone (CaCO₄) from supply 132 into the Steam Drum Generators 126 and used to capture SOₓ as gypsum (CaSO₄) which falls to the bottom of Steam Drum Generators 126 into container 133 to be used elsewhere. Carbon dioxide may be removed and captured from the remaining flue gases by a membrane apparatus or other known process in apparatus 129 which is connected to Steam Drum Generators 126.

In a typical 40,000 bpd bitumen recovery operation, the Steam Drum Generators 126 consume about 1.5 to 2.5 million BTUs per hour and produce about 100,000 to 200,000 bpd of steam (bpd expressed as Cold Water Equivalent (“CWE”)). Apparatus 129 captures about 3,500 tons of CO₂ per day and about 1.3 tons of SO₂ per day are captured through the use of a Flue Gas De-sulphurization (“FGD”) process.

Steam is also used to generate a substantial portion or all of the power requirements at site (in the approximate range of 50 to 80 MW for a 40,000 bpd operation). A Steam Turbine generator 128 operates at conditions such that low pressure saturated steam is returned to the Rising Tube Evaporator (or Falling Tube Evaporator) 123.

The use of residual gases from the Plasma Arc Reactor to fuel the Steam Drum Generators 126 which in turn provide steam to (1) maintain operating conditions in an underground SAGD steam chamber and 2) power a Steam Turbine generator that produces electrical power, significantly increases the overall cycle efficiency of the SAGD or other thermal recovery operation. However, as discussed below, a Gas Turbine may be preferable to a Steam Turbine for generating electrical power.

### Alternate Power Generation

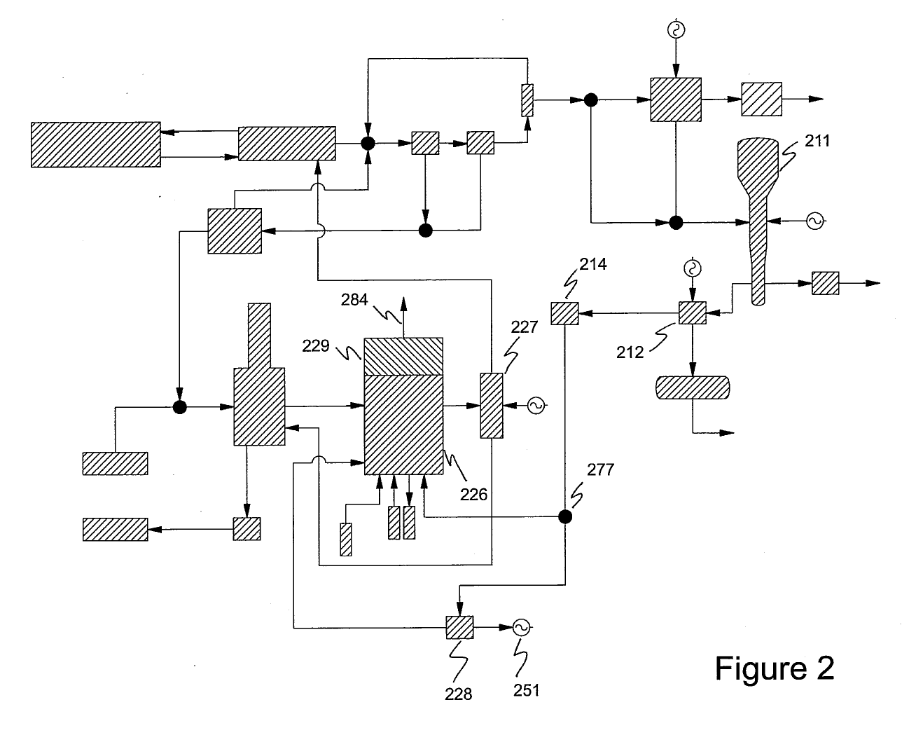

FIG. 2 is a schematic of an alternate flow process for separating water from bitumen, upgrading the bitumen and recovering methane and other fuel gases from the upgrader. The components of the process are the same as those of the process shown in FIG. 1 except that the steam turbine 128 is replaced by a gas turbine 228. The gas turbine is fueled by fuel gases generated by the Plasma Arc Reactor 211 and separated in the Gas Refrigeration Plant 212. In this configuration power is generated directly by the fuel gases produced instead of going through the additional step of generating steam to run a steam turbine for power generation.

As before, a Plasma Arc Reactor 211 breaks down the bitumen-asphaltene fuel and produces gases and some solid residues. The gases resulting from the Plasma Arc Reactor combustion are subsequently fed to a Gas Refrigeration Plant 212. As before, this process separates out other gases such as, for example, methane CH₄, ethane C₂H₆, carbon monoxide (CO), carbon dioxide (CO₂), hydrogen sulphide (H₂S) and NOxs. These fuel gases may be captured such as for example in a tank 214 or a portion fed directly to the Gas Turbine 228 and a portion to the Steam Drum Generators 226. The amount of fuel gas sent to the Steam Drum Generators 226 and Gas Turbine 228 is controlled at junction 277. Typically about 5% to 20% of the fuel gas produced in the Gas Refrigeration Plant 212 is diverted to power the Gas Turbine 228 which in turn generates from 50 MW to 80 MW of electrical power for the example of a 40,000 bpd operation.

### Power Requirements and Energy Balance

In the example of a 40,000 bpd SAGD bitumen recovery operation, an estimated 50 to 80 MW of electrical power is required to operate the on-site recovery, partial upgrading and other treatment facilities. In the configuration of FIG. 1, at least a portion of this power may be generated by a Steam Turbine 128 using a portion of the steam produced by the operation's Steam Drum Generators 126. The Steam Turbine electrical power generation is shown on FIG. 1 as power output 151. In the present example, about 20,000 bpd CWE of high-grade steam per day diverted from the High Pressure Steam Separator 127 will produce about 8 to 10 MW from a steam turbine. This is about 15% of the high-grade steam produced by the Steam Drum Generators 126.

In the alternate configuration of FIG. 2, at least a portion of this power may be generated by a Gas Turbine 228 using a portion of the fuel gas produced by the Plasma Arc Reactor 211. The Gas Turbine electrical power generation is shown on FIG. 2 as power output 251. In the present example, about 8,000 MMBTU of fuel gas energy per day from the Plasma Arc Reactor 211 will produce about 60 to 80 MW from a Gas Turbine. This is about 15% of the fuel gas energy produced by the by the Plasma Arc Reactor 211.

The principal electrical power consumers in the process of the present invention are the partial upgrader 106 with power input 164, the Gas Refrigeration Plant 112 with power input 163, the High Pressure Steam Separator 127 with power input 161 and the Plasma Arc Reactor 111 with power input 162. Up to 60 MW of the total power consumed is required to operate the electrodes of the Plasma Arc Reactor. With the electrical arc, the Plasma Arc Reactor burns a combination of asphaltene residue from the upgrading process mixed with a small portion of the bitumen recovered from the SAGD or thermal recovery operation. The Plasma Arc Reactor and Refrigeration Plant produce enough methane and other fuel gases to power the Steam Drum Generators.

The process in the above 40,000 bpd example produces about 32,000 bpd of ˜20° API de-asphalted crude oil which contains approximately 198 terrajoules (“TJ”) of low heat value energy. Thus 198 TJ of energy are produced per day as the product of the operation.

If the recovery operation facilities consume 80 MW of power, approximately 6.91 TJ will be generated as electrical energy per day. A significant portion of the methane and other fuel gases from the Plasma Arc Reactor are used to generate the 48.1 TJ of energy per day to power the Steam Drum Generators.

In summary, the approximate energy balance of the process of the present invention for a 40,000 BPD SAGD operation is:

| | |
|---|---|
| Energy of Bitumen Recovered | 246 TJ/day (2,847 MW) |
| Energy of ~20°API Product for Sale | 198 TJ/day (2,292 MW) |
| Energy to Produce Steam for all Operations | 48 TJ/day (555 MW) |
| | 246 TJ/day |

### Water, Bitumen and Gas Mass Balance

The mass balance of principal materials in the flow process of the present invention are described briefly below.

### Water

In the example of a 40,000 bpd SAGD bitumen recovery operation, the mass of water/steam recovered per day from the steam chamber is 129,000 bpd. Most of this is recovered by de-oiling and an additional 10,514 bpd of make-up water is added. The Rising Tube Evaporator must process 158,578 bpd which includes the recovered water, the make-up water, 4,064 bpd of condensate from the High Pressure Steam Separator and 15,000 bpd of low grade steam from the outlet of the steam turbine. The Steam Drum Generators must process 163,578 bpd of water/steam which is the total output from the Rising Tube Evaporator. The High Pressure Steam Separator must also process 158,578 bpd of water/steam; 4,064 bpd of which is low grade steam or condensate which is returned to the Rising Tube Evaporator; 15,000 bpd of which is high-grade steam required to power the steam turbine; and the remaining 139,514 bpd of high-grade steam which is injected back into the SAGD steam chamber. Of the steam injected into the steam chamber, approximately 10,514 bpd is lost as condensed water to the reservoir.

| | |
|---|---|
| Water Recovered from Steam Chamber | 129,000 bpd |
| Make-Up Water Added | 10,514 bpd |
| | 139,514 bpd |
| Water Returned to Steam Chamber | 139,154 bpd |
| Water Lost in the Reservoir | 10,514 bpd |
| | 139,514 bpd |

### Bitumen

In the SAGD example above, the mass of bitumen recovered per day from the steam chamber is 40,000 bpd. Of this, 2,000 bpd is set aside for use as a fuel additive for the Plasma Arc Reactor. The remaining 38,000 bpd is sent to the partial upgrader which produces 32,000 bpd of 20° API de-asphalted oil. The partial upgrader leaves 6,000 bpd as asphaltene residue which is added to the 2,000 bpd bitumen set-aside to comprise the fuel for the Plasma Arc Reactor. Most of the 8,000 bpd Plasma Arc Reactor fuel ends up as the gases that are sent to the Gas Refrigeration Plant.

| | |
|---|---|
| Bitumen Recovered from Steam Chamber | 40,000 bpd |
| Bitumen Converted to 20 API de-asphalted oil | 32,000 bpd |
| Bitumen Set Aside for Plasma Arc Reactor Fuel | 2,000 bpd |
| Bitumen Converted to Asphaltene Residue | 8,000 bpd |
| | 40,000 bpd |

### Gas

In the SAGD example above, the volume of gas recovered per day from the steam chamber at a GOR of 2 is 80 Mscf, of which approximately 64 Mscf is methane. An additional 65,000 Mscf of fuel and other gases are generated from the Plasma Arc Reactor and Gas Refrigeration Plant of which about 75% or 50,000 Mscf is methane or methane equivalent fuel gas.

Assuming that most of the fuel gas available is methane, the energy available by burning this gas is estimated at 0.945 megajoules (“MJ”) per Mscf. Thus a total of 50,000 Mscf fuel gas can generate about 47 million MJ per day or 45 billion BTU per day.

| | |
|---|---|
| Methane Recovered from Steam Chamber | 64 Mscf |
| Methane Recovered from Gas Refrigeration Plant | 50,000 Mscf |
| | 50,000 Mscf |

Thus the Steam Drum Generators operating at 85% efficiency should be able to convert 38 billion BTU of energy per day or 1.6 billion BTU per hour into steam. The rated power of the Steam Drum Generators is therefore about 470 MW.

A number of variations and modifications of the invention can be used. As will be appreciated, it would be possible to provide for some features of the invention without providing others. For example, the fuels produced in the plasma arc reactor can be used to produce electrical energy using a gas turbine for example and this electrical energy can be sold to the power grid. This could be a preferred strategy if the feedstock is recovered by a mining technique or by an in-situ method such as VAPEX which does not require steam or electrical energy to mobilize the in-situ bitumen for recovery.

The present invention, in various embodiments, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
providing a heavy oil- and/or bitumen-containing feed material; and
inputting at least a portion of the feed material into a plasma arc reactor at a selected combustion temperature to produce a desired composition of a paraffin-containing product.

2. The method of claim 1, wherein providing comprises:
separating most water from the heavy oil- and/or bitumen-containing feed material to form separated water and a separated heavy oil- and/or bitumen-containing feed material;
removing any hydrocarbons remaining in the separated water to form de-oiled water and a bitumen mixture; and
distilling the de-oiled water for later conversion into steam, the steam to be at least one of injected into an underground formation and used in a steam turbine.

3. The method of claim 2, wherein the separated heavy oil- and/or bitumen-containing feed material comprises diluent and further comprising:
removing residual water from the bitumen mixture to form removed water and a treated hydrocarbon mixture, the treated hydrocarbon mixture comprising most of the diluent in the bitumen mixture;
combining the removed water with the separated water before distillation; and
removing at least most of the diluent from the treated hydrocarbon mixture to form a resulting hydrocarbon mixture.

4. The method of claim 3, wherein the resulting hydrocarbon mixture comprises at least about 20% by weight asphaltenes and further comprising:
upgrading the resulting hydrocarbon mixture to form a de-asphalted oil and a residue, the residue comprising at least most of the asphaltenes in the resulting hydrocarbon mixture, wherein the residue is the at least a portion of the heavy oil- and/or bitumen-containing feed material.

5. The method of claim 4, wherein a fuel to the plasma arc reactor comprises at least first and second parts, wherein a portion of the residue is the first part, and wherein a portion of the bitumen mixture is the second part.

6. The method of claim 1, wherein the combustion temperature determines the desired composition of the paraffin-containing product and wherein the combustion temperature is varied to produce a paraffin product containing a plurality of hydrogen, methane, ethane, butane, and propane.

7. The method of claim 6, further comprising:
cooling the paraffin product but maintaining the temperature of the product above a boiling point of hydrogen sulfide to separate natural gas liquid products from gaseous hydrocarbons.

8. The method of claim 6, wherein the gaseous hydrocarbons are used to power a circular fluidized boiler to produce steam, a first portion of which is injected into an underground hydrocarbon-containing deposit and a second portion of which is used to power a steam turbine to produce electrical power.

9. The method of claim 6, wherein the gaseous hydrocarbons are used to power a gas turbine to produce electrical power.

10. A method, comprising:
providing a heavy oil- and/or bitumen-containing feed material, the feed material comprising at least about 20% by weight asphaltenes;
separating the feed material into an oil component and a residue, the residue comprising at least most of the asphaltenes in the feed material; and
converting the residue into a paraffin-containing product, the product comprising a mixture of paraffins.

11. The method of claim 10, wherein at least a portion of the paraffin-containing product is combusted to power a steam generating unit, the steam generating unit outputting a first portion of steam which is injected into an underground heavy oil and/or bitumen-containing deposit and a second portion of steam which is used to power a steam turbine.

12. The method of claim 11, wherein the feed material was removed from the deposit.

13. The method of claim 10, wherein a temperature of the converting step controls a degree of cracking of carbon chains and is selected to produce a desired mixture of hydrogen, methane, ethane, butane, and propane.

14. The method of claim 13, wherein different temperatures produce differing mixtures of hydrogen, methane, ethane, butane, and propane.

15. The method of claim 10, further comprising:
cooling the paraffin-containing product but maintaining the temperature of the paraffin-containing product above a boiling point of hydrogen sulfide to separate hydrocarbon-containing liquid products from hydrocarbon-containing gaseous products.

16. A system, comprising:
a plurality of wells, each of the wells at least one of injecting at least one of steam, water, heat, and diluent into an underground heavy oil- and/or bitumen-containing deposit and removing, from the deposit, a mobilized heavy oil- and/or bitumen-containing stream;
a plasma arc reactor operable to convert a portion of the stream into a paraffin-containing product; and
a steam generator operable to use energy from combustion of at least a part of the paraffin-containing product to produce steam for at least one of (a) injection, by at least some of the wells, into the deposit and (b) powering a steam turbine to produce electrical power.

17. The system of claim 16, further comprising:
a free water knock-out unit to separate most of the water from the mobilized heavy oil- and/or bitumen-containing stream to form separated water and a treated heavy oil- and/or bitumen-containing stream comprising a diluent; and
an oil treating unit to remove at least most of the diluent from the treated heavy oil- and/or bitumen-containing stream.

18. The system of claim 16, wherein the heavy oil- and/or bitumen-containing stream comprises at least about 20% by weight asphaltenes and further comprising:
an upgrader to separate the heavy oil- and/or bitumen-containing stream into a de-asphalted oil component and a residue comprising at least most of the asphaltenes, wherein a fuel to the plasma arc reactor comprises at least first and second parts, wherein a portion of the residue is the first part, and wherein a part of the portion of the stream is the second part.

19. The system of claim 16, further comprising:
a gas refrigeration plant to cool a temperature of the mixture of paraffin-containing product to a temperature above the boiling point of hydrogen sulfide to form a natural gas liquid product and a hydrocarbon gas-containing component, wherein the at least a part of the paraffin-containing product is the hydrocarbon gas-containing component.

20. The system of claim 17, further comprising:
at least one of a rising tube evaporator and falling tube evaporator to distill at least a portion of the separated water to provide water for conversion into steam.

21. The system of claim 17, further comprising:
a de-oiling unit to remove any oil in the separated water.

22. The system of claim 16, wherein at least part of the paraffin-containing product is used to provide electrical energy for the plasma arc reactor.

23. The system of claim 19, wherein the paraffin-containing product comprises hydrogen, methane, ethane, butane, and propane.
